(19) United States
(12) Patent Application Publication
(10) Pub. No.: US 2025/0269654 A1
(43) Pub. Date: Aug. 28, 2025

(54) INK LIQUID LEVEL HEIGHT MEASURING APPARATUS AND IMAGE FORMING APPARATUS

(71) Applicant: Konica Minolta, Inc., Tokyo (JP)

(72) Inventor: Shiori TSUGAWA, Kyoto (JP)

(21) Appl. No.: 19/024,274

(22) Filed: Jan. 16, 2025

(30) Foreign Application Priority Data
Feb. 22, 2024 (JP) 2024-025674

(51) Int. Cl. B41J 2/175; B41J 2/045; G01F 23/72

(52) U.S. Cl. CPC B41J 2/17566; B41J 2/0451; B41J 2/04573; B41J 2/04586; B41J 2/17563; B41J 2/17596; G01F 23/72

(57) ABSTRACT

Provided is an ink liquid level height measuring apparatus that measures a liquid level height of ink in a container. The ink liquid level height measuring apparatus includes: a float that includes a magnet and moves in association with a change in the liquid level height; a Hall element that detects, as a continuous value, a change in magnetic flux density due to the magnet that moves together with the float; and at least one hardware processor. The at least one hardware processor adjusts the liquid level height to a reference height, acquires an output value of the Hall element, when the liquid level height is the reference height, and corrects the liquid level height based on the output value.

### CROSS REFERENCE TO RELATED APPLICATIONS

The entire disclosure of Japanese Patent Application No. 2024-025674, filed on Feb. 22, 2024, is incorporated herein by reference in its entirety.

### BACKGROUND

### Technological Field

The present invention relates to an ink liquid level height measuring apparatus and an image forming apparatus.

### Description of Related Art

In an inkjet-type image forming apparatus, a tank that stores ink to be supplied to an inkjet head is provided with an ink liquid level height measuring apparatus that measures the liquid level height of the ink in the tank.

In the invention disclosed in Japanese Patent Publication Laid-Open No. 2021-783, an ink liquid level height measuring apparatus is configured to measure the upper and lower limits of the liquid level in order to detect an abnormality of a component of an ink supply apparatus for supplying ink to a tank. The liquid level height measured by the ink liquid level height measuring apparatus is not a continuous value but a discrete value between the upper and lower limits, and the liquid level height between the upper and lower limit is unknown. For this reason, there has been a problem in that it is difficult to detect an abnormality of a component of the ink supply apparatus at a value other than the upper and lower limits, or that even when an abnormality can be detected, the detection accuracy is insufficient.

In the invention disclosed in Japanese Patent Publication Laid-Open No. 2020-34485, an ink liquid level height measuring apparatus is disclosed which is capable of continuously measuring changes in the liquid level height of ink in a tank by using a capacitive sensor. However, the capacitive sensor has a problem in that sensitivity cannot be obtained depending on the physical properties of ink.

The inventions disclosed in Japanese Patent Publication Laid-Open No. 2021-783 and Japanese Patent Publication Laid-Open No. 2020-34485 involve the above-described problems. In this respect, the present inventor has considered a method using a Hall element as a method of continuously measuring changes in the liquid level height of ink without depending on the physical properties of ink. In order to accurately detect an abnormality of a component of an ink supply apparatus, it is necessary to measure minor changes in the liquid level height, but the Hall element has a characteristic that an output value thereof changes over time (drifts).

### SUMMARY

An object of the present invention is to provide an ink liquid level height measuring apparatus and an image forming apparatus each capable of accurately measuring the liquid level height of ink by using a Hall element even when there is a change over time.

In order to achieve at least one of the above-described objects, an ink liquid level height measuring apparatus reflecting one aspect of the present invention is an ink liquid level height measuring apparatus for measuring a liquid level height of ink in a container and includes: a float that includes a magnet and moves in association with a change in the liquid level height; a Hall element that detects, as a continuous value, a change in magnetic flux density due to the magnet that moves together with the float; and at least one hardware processor, and the at least one hardware processor adjusts the liquid level height to a reference height, and acquires an output value of the Hall element, when the liquid level height is the reference height, and corrects the liquid level height based on the output value.

In order to achieve at least one of the above-described objects, an image forming apparatus reflecting one aspect of the present invention includes: a container that stores ink; an image former that forms an image by using the ink supplied from the container; and the ink liquid level height measuring apparatus described above.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating examples of an image forming apparatus and an ink liquid level height measuring apparatus according to an embodiment of the present invention;

FIG. 2 is a block diagram illustrating a main part of a control system of the image forming apparatus illustrated in FIG. 1;

FIG. 3 is a flowchart illustrating zero-point correction of a Hall sensor of the ink liquid level height measuring apparatus;

FIG. 4A is a graph illustrating the relationship between the liquid level height before zero-point correction and the sensor output value;

FIG. 4B is a graph illustrating the relationship between the liquid level height after zero-point correction and the sensor output value;

FIG. 5A illustrates the relationship between the zero-point drift amount and the deviation in the measured value in the case of no zero-point correction;

FIG. 5B illustrates the relationship between the zero-point drift amount and the deviation in the measured value in the case of zero-point correction;

FIG. 6 is a flowchart illustrating entire-region correction of the Hall sensor of the ink liquid level height measuring apparatus;

FIG. 7A illustrates initial states of a first sub-tank and a second sub-tank in the entire-region correction illustrated in FIG. 6;

FIG. 7B illustrates a state in which liquid level alignment is performed in the first sub-tank and the second sub-tank in the entire-region correction illustrated in FIG. 6;

FIG. 7C illustrates a state in which the first sub-tank is hermetically sealed in the entire-region correction illustrated in FIG. 6;

FIG. 7D illustrates a state in which ink is being fed from the first sub-tank to the second sub-tank in the entire-region correction illustrated in FIG. 6;

FIG. 8A illustrates the relationships of the liquid level height and the sensor output value in the second sub-tank to the pressure value in the first sub-tank in the entire-region correction illustrated in FIG. 6;

FIG. 8B is a graph illustrating the relationship between the sensor output value and the liquid level height, which is obtained from the relationships illustrated in FIG. 8A;

FIG. 9 is a graph illustrating the relationship between the pump driving time and the liquid level height from a state in which an ink supply section is a new product to a state in which the ink supply section is determined to have a failure; and

FIG. 10 is a graph illustrating a determination result obtained by making determination based on a change over time in the liquid feed amount of ink supplied for a predetermined time.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present invention will be described in detail with reference to the accompanying drawings.

### [Image Forming Apparatus]

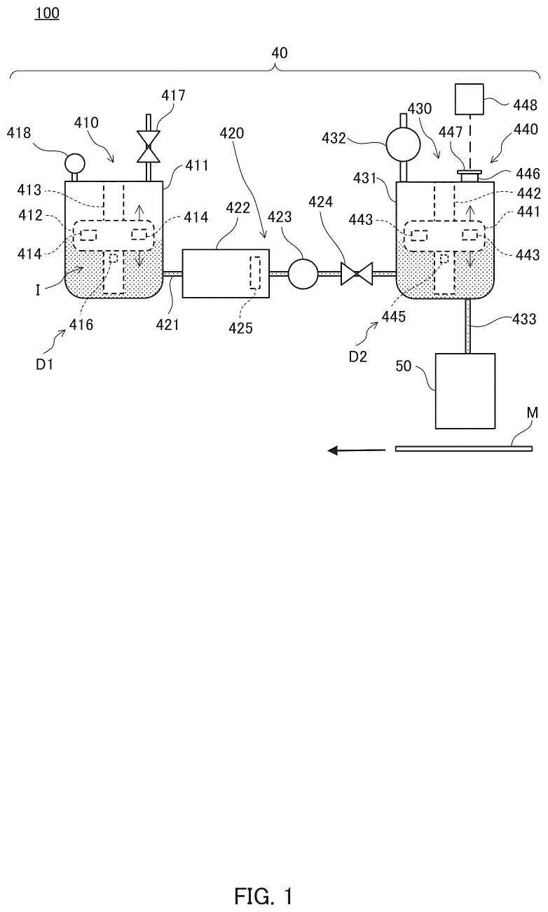

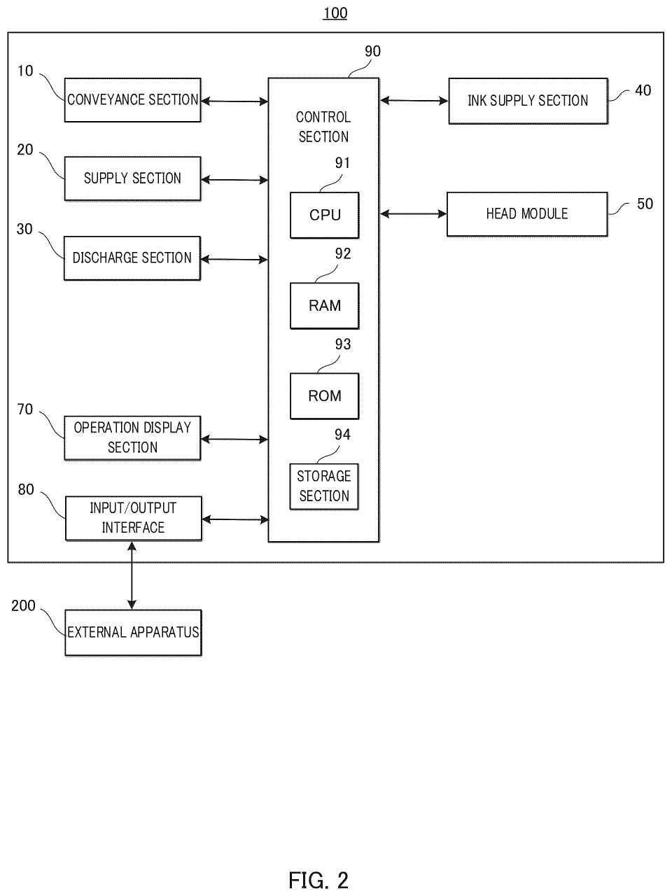

FIG. 1 is a schematic diagram illustrating examples of an inkjet printer 100 (the image forming apparatus in the present invention) and an ink liquid level height measuring apparatus 440 according to the present embodiment. FIG. 2 is a block diagram illustrating a main part of a control system of the inkjet printer 100 illustrated in FIG. 1.

As illustrated in FIG. 2, the inkjet printer 100 includes a conveyance section 10, a supply section 20, a discharge section 30, an ink supply section 40, a head module 50 (the image forming section (image former) in the present invention), an operation display section 70, an input/output interface 80, a control section 90, and the like.

The conveyance section 10 conveys a recording medium M (see FIG. 1). The conveyance section 10 is constituted by, for example, a conveyance belt, a conveyance drum, and the like. The recording medium M supplied from the supply section 20 is conveyed to the head module 50 by a conveyance operation of the conveyance section 10. Thereafter, the recording medium M on which an image has been formed by the head module 50 is conveyed to the discharge section 30 by a conveyance operation of the conveyance section 10.

As the recording medium M, it is possible to use various media on which ink ejected from an inkjet head (illustration is omitted) of the head module 50 can be fixed. The recording medium M is, for example, a medium such as sheet-like paper, cloth (fabric), or resin. The recording medium M is not limited to a sheet-like medium, and may be a medium such as roll-shaped paper, cloth, or resin.

The supply section 20 stores the recording medium M and supplies the recording medium M to the conveyance section 10. The supply section 20 includes, for example, a storage section that stores the recording medium M, and includes a belt, a roller, and the like that convey the recording medium M to the conveyance section 10.

The discharge section 30 stores the recording medium M discharged from the conveyance section 10. The discharge section 30 includes, for example, a belt, a roller, and the like that convey the recording medium M from the conveyance section 10, and includes a storage section that stores the recording medium M.

The ink supply section 40 is an apparatus that supplies ink I to the head module 50. The ink supply section 40 includes a first sub-tank section 410, a liquid feed section 420, a second sub-tank section 430, the ink liquid level height measuring apparatus 440, and the like.

The first sub-tank section 410 stores the ink I to be fed to the second sub-tank section 430. The first sub-tank section 410 includes a first sub-tank 411 (the supply source container in the present invention) or the like that stores the ink I. The first sub-tank 411 is connected to a main tank (illustration is omitted) that stores the ink I via a liquid feed path (illustration is omitted). The ink I stored in the main tank is fed to the first sub-tank 411 by using a pump or the like (illustration is omitted).

In addition, the first sub-tank section 410 includes, as a reference height detection section D1 that detects whether the liquid level height of the ink I in the first sub-tank 411 is the reference height, a float 412, a guide section 413, a magnet 414, and a reed switch 416.

The float 412 is a floating body that floats on the liquid level of the ink I. In a plan view, a through-hole into which the guide section 413 is inserted is formed in a center portion of the float 412.

The guide section 413 is a rod-shaped member that includes an end part supported by a side of a top plate of the first sub-tank 411 and extends downward. The guide section 413 is inserted into the through-hole of the float 412. The guide section 413 regulates the float 412 such that the float 412 does not tilt, and guides the float 412 such that the float 412 is movable in the vertical direction that is a liquid level height direction, that is, the float 412 is movable up and down. Accordingly, the float 412 moves up and down along the guide section 413 as the liquid level of the ink I moves up and down.

Note that the guide section 413 may be a rod-shaped member that extends upward and includes an end part supported by a side of a bottom plate of the first sub-tank 411 as long as the guide section 413 can regulate the float 412 such that the float 412 does not tilt, and can guide the float 412 such that the float 412 is movable up and down. Further, as long as the float 412 can be regulated so as not to tilt, the guide section 413 and the through-hole of the float 412 may be omitted. For example, when the outer peripheral side surface of the float 412 is formed so as to be in proximity to the inner wall of the first sub-tank 411, the inner wall of the first sub-tank 411 functions as a guide section that regulates the float 412 such that the float 412 does not tilt, and guides the float 412 such that the float 412 is movable up and down.

The magnet 414 which is a permanent magnet is disposed inside the float 412. The magnet 414 is, for example, an annular body having a rectangular cross section. The magnet 414 is disposed, inside the float 412, in a position in which the float 412 floating on the liquid level of the ink I is balanced so as not to tilt.

The reed switch 416 is a sensor that detects whether the liquid level height of the ink I in the first sub-tank 411 is the reference height, and is disposed at the reference height. The reed switch 416 is a magnetic switch that is turned on or off by a magnetic force, and is turned on by the magnetic force of the magnet 414 in the float 412 when the liquid level height of the ink I is the reference height, and is turned off otherwise.

In this manner, in the first sub-tank section 410, the reference height detection section D1 detects whether the liquid level height of the ink I in the first sub-tank 411 is the reference height. Note that, although a float-type level switch is exemplified here as the reference height detection section D1, another type, for example, a capacitive level switch or the like may also be used.

In addition, the first sub-tank unit 410 includes a valve 417, which seals the upper space of the first sub-tank 411 and releases the upper space to the atmosphere, and a pressure sensor 418, which detects the pressure in the first sub-tank 411. The valve 417 and the pressure sensor 418 are used for correction to be described later.

The liquid feed section 420 feeds the ink I stored in the first sub-tank 411 to the second sub-tank section 430 (a second sub-tank 431 to be described later). The liquid feed section 420 includes a tank supply path 421 (the ink supply path in the present invention), a deaeration module 422, a liquid feed pump 423, a liquid feed valve 424, and the like.

The tank supply path 421 connects the first sub-tank 411 to the second sub-tank 431, and serves as a flow path from the first sub-tank 411 to the second sub-tank 431. The deaeration module 422 includes a filter 425. The deaeration module 422 deaerates the ink I to be fed, and filters the ink I with the filter 425.

The liquid feed pump 423 is a pump that feeds the ink I from the first sub-tank 411 to the second sub-tank 431. The liquid feed valve 424 opens and closes the tank supply path 421. For example, the liquid feed valve 424 opens when the ink I is fed from the first sub-tank 411 to the second sub-tank 431, and the liquid feed valve 424 closes when the ink I is fed from the second sub-tank 431 to the head module 50.

The second sub-tank section 430 stores the ink I to be fed to the head module 50. The second sub-tank section 430 includes the second sub-tank 431 (the container in the present invention) that stores the ink I, a pneumatic pump 432, a head supply path 433, the ink liquid level height measuring apparatus 440, and the like.

The second sub-tank 431 is connected to the first sub-tank 411 via the tank supply path 421, and is connected to the head module 50 via the head supply path 433.

The pneumatic pump 432 is connected to an upper portion of the second sub-tank 431, and controls the pressure in an upper space of the second sub-tank 431 to a desired pressure. The head supply path 433 connects a lower portion of the second sub-tank 431 to the head module 50, and supplies the ink I from the second sub-tank 431 to the head module 50.

The second sub-tank section 430 described above is provided with the ink liquid level height measuring apparatus 440 that measures the liquid level height of the ink I in the second sub-tank 431. The ink liquid level height measuring apparatus 440 may also be provided in the first sub-tank section 410 to measure the liquid level height of the ink I in the first sub-tank 411. The ink liquid level height measuring apparatus 440 will be described later.

The head module 50 includes apparatuses and members necessary for image formation, such as an inkjet head. The head module 50 ejects, from a nozzle of the inkjet head, the ink I supplied from the ink supply section 40 (the second sub-tank section 430) to form an image on the recording medium M.

Note that, in FIG. 1, in order to simplify the drawing, the ink supply section 40 and the head module 50 for one color are illustrated, but ink supply sections 40 and head modules 50 are disposed according to the number of colors to be used. For example, in a case where four colors of yellow (Y), magenta (M), cyan (C), and black (K) are used, ink supply sections 40 and head modules 50 for the four colors are disposed.

The operation display section 70 is, for example, a flat panel display, such as a liquid crystal flat panel display or an organic electro luminescence (EL) flat panel display, with a touch screen. The operation display section 70 displays an operation menu for the user, information on image data, various states of the inkjet printer 100, and the like. In addition, the operation display section 70 includes a plurality of keys, and receives various input operations of the user.

The input/output interface 80 mediates transmission and reception of data between an external apparatus 200 and the control section 90. Input/output interface 80 is constituted by, for example, one of various serial interfaces and various parallel interfaces, or a combination thereof.

The external apparatus 200 is, for example, a personal computer, a facsimile machine, or the like, and supplies a print job, image data, and the like, to the control section 90 via the input/output interface 80.

The control section 90 includes a central processing unit (CPU) 91, a random access memory (RAM) 92, a read only memory (ROM) 93, a storage section 94, and the like as illustrated in FIG. 2.

The CPU 91 reads various control programs and setting data stored in the ROM 93, stores the read programs and setting data in the RAM 92, and executes the programs to carry out various pieces of calculation processing. For example, the control section 90 generates, based on image data received from the input/output interface 80, a driving signal for an image to be formed, and outputs the driving signal to the inkjet head.

The RAM 92 provides a working memory space for the CPU 91 and stores temporary data. Note that, the RAM 92 may include a non-volatile memory.

The ROM 93 stores the various control programs to be executed by the CPU 91, the setting data, and the like. Note that, a rewritable non-volatile memory such as an electrically erasable programmable read only memory (EEPROM) or a flash memory may also be used instead of the ROM 93.

The storage section 94 stores a print job and image data associated with a print job, which are inputted from the external apparatus 200 via the input/output interface 80. As the storage section 94, for example, a hard disk drive (HDD), a solid state drive (SSD) or the like is used, and a dynamic random access memory (DRAM) or the like may also be used in combination.

The conveyance section 10, the supply section 20, the discharge section 30, the ink supply section 40, the head module 50, the operation display section 70, the input/output interface 80, and the like are connected to the control section 90. The control section 90 integrally controls the entire operation of the inkjet printer 100. The conveyance section 10, the supply section 20, the discharge section 30, the ink supply section 40, the head module 50, the operation display section 70, the input/output interface 80, and the like are controlled by the control section 90 to execute predetermined processing.

With the above-described configuration, the inkjet printer 100 supplies the recording medium M from the supply section 20 to the conveyance section 10, forms an image on the recording medium M, which is conveyed by the conveyance section 10, with the head module 50, and conveys the recording medium M, on which the image has been formed, to the discharge section 30.

### [Ink Liquid Level Height Measuring Apparatus]

As illustrated in FIG. 1, the second sub-tank section 430 of the ink supply section 40 is provided with the ink liquid level height measuring apparatus 440. The ink liquid level height measuring apparatus 440 includes a float 441, a guide section 442, a magnet 443, a reed switch 445, a Hall sensor 446, a magnetic body 447, and a measurement control section 448.

The second sub-tank section 430 includes, as a reference height detection section D2 that detects whether the liquid level height of the ink I in the second sub-tank 431 is the reference height, the float 441, the guide section 442, the magnet 443, and the reed switch 445.

The float 441, the guide section 442, the magnet 443, and the reed switch 445 have the same configurations as those of the float 412, the guide section 413, the magnet 414, and the reed switch 416 in the reference height detection section D1, and overlapping descriptions thereof will be omitted here. Here, the guide section 442 regulates the movement of the float 441 in the horizontal direction such that the position of the magnet 443 with respect to the Hall sensor 446 does not change in the horizontal direction along the liquid level.

In the second sub-tank section 430, the reference height detection section D2 detects whether the liquid level height of the ink I in the second sub-tank 431 is the reference height. Note that, although a float-type level switch is also exemplified here as the reference height detection section D2, another type, for example, a capacitive level switch or the like may be also used.

The Hall sensor 446 is a magnetic sensor using a Hall element that detects the strength of a magnetic field. The Hall sensor 446 may include an operational amplifier circuit or the like.

The Hall sensor 446 is disposed in a position in which the Hall sensor 446 can measure a change in magnetic flux density due to the magnet 443 that moves up and down together with the float 441, preferably, in a position in which the magnetic flux density increases. For example, the Hall sensor 446 is fixed to a side of a top plate of the second sub-tank 431 together with the magnetic body 447, and is disposed in a position in which the Hall sensor 446 and the magnetic body 447 face the magnet 443 in the vertical direction.

With the above-described configuration, the Hall sensor 446 detects, as a continuous value, a change in the magnetic flux density, which is a change in the physical quantity associated with a change in the liquid level height, and outputs the sensor output value.

The magnetic body 447 is a member made of a material having a high magnetic permeability such as iron, for example, SS400 which is a rolled steel material for general structure. Usually, the magnetic field is distorted so as to be directed toward a material a having high magnetic permeability, for example, a magnetic body, and the magnetic flux is concentrated. Accordingly, by disposing the magnetic body 447 in proximity to the Hall sensor 446, the magnetic flux from the magnet 443 can be concentrated in the position of the Hall sensor 446 to increase the magnetic flux density.

In particular, in a case where the magnet 443 is disposed on the side beneath the Hall sensor 446, the magnetic flux density in the sensor position is larger when the magnetic body 447 is disposed in proximity to and on the upper side of a housing of the Hall sensor 446. Accordingly, in FIG. 1, as an example, the magnetic body 447 is disposed on the upper surface of the housing of the Hall sensor 446. Further, as the size (width, thickness, and depth) of the magnetic body 447 increases, the magnetic flux density in the sensor position increases.

Since the magnetic body 447 is disposed on and in proximity to the upper side of the housing of the Hall sensor 446, the Hall sensor 446 detects, as a continuous value, the liquid level height of the ink I, that is, the magnetic flux density that changes as the float 441 moves up and down, with high sensitivity, and outputs an output value corresponding to the liquid level height. As a result, the ink liquid level height measuring apparatus 440 can continuously measure the liquid level height of the ink I with high accuracy.

Note that, the Hall sensor 446 and the magnetic body 447 may be fixed to a side of a bottom plate of the second sub-tank 431, and may be disposed in a position in which the Hall sensor 446 and the magnetic body 447 face the magnet 443 in the vertical direction. In that case, the magnetic body 447 is desirably disposed on the lower surface of the housing of the Hall sensor 446.

Although illustration is omitted, the measurement control section 448 includes a CPU, a RAM, a ROM, a storage section, and the like. The CPU reads a program and data stored in the ROM, stores the read program and data in the RAM, and executes the program to carry out various pieces of processing. For example, the measurement control section 448 obtains the liquid level height based on the output value from the Hall sensor 446.

Incidentally, as described above, the Hall element used in the Hall sensor 446 has a characteristic that an output value thereof changes over time (drifts).

Accordingly, in the present embodiment, in order to accurately measure the liquid level height of the ink I by the Hall sensor 446 including the Hall element even when there is a change over time, the ink liquid level height measuring apparatus 440 has a configuration to be described below.

Specifically, the ink liquid level height measuring apparatus 440 includes an adjustment section, which adjusts the liquid level height of the ink I to the reference height, and a correction section (corrector), which corrects the liquid level height based on the output of the Hall sensor 446 when the liquid level height is the reference height. Here, the measurement control section 448 may be constituted by at least one hardware processor, in which case the at least one hardware processor functions as the adjustment section and the correction section, and also functions as an acquisition section (acquirer) and a determination section both of which will be described later. In addition, the adjustment section and the correction section, as well as the acquisition section and the determination section both of which will be described later, may be provided as functions of the measurement control section 448, for example, may be provided as programs that are executed by the measurement control section 448.

### [Correction 1]

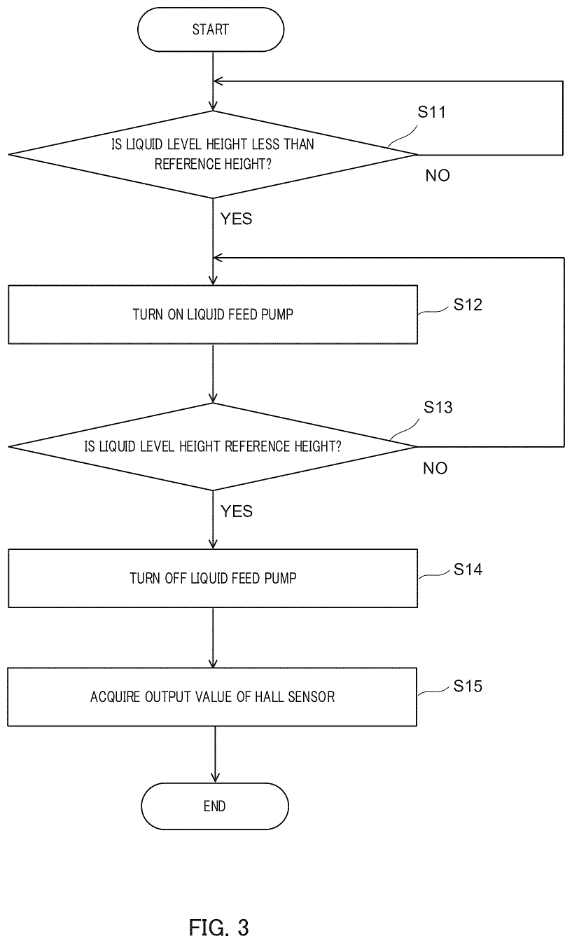

Correction 1 (zero-point correction), which is an example of correction using the adjustment section and the correction section, will be described with reference to FIG. 3 together with FIG. 1. FIG. 3 is a flowchart illustrating zero-point correction of the Hall sensor 446 of the ink liquid level measuring apparatus 440. Further, since the correction is performed here at the zero point, that is, the lower limit, the reference height in the reference height detection section D2 is set to the lower limit of the second sub-tank 431.

In the inkjet printer 100, when an image is formed on the recording medium M by a print job, the ink I in the second sub-tank 431 is consumed, and the liquid level height of the ink I in the second sub-tank 431 becomes less than the reference height (the lower limit). As seen above, the zero-point correction to be described below is executed when the liquid level height of the ink I in the second sub-tank 431 becomes less than the reference height (the lower limit) during image formation by a print job.

### (Step S11)

The measurement control section 448 (the adjustment section) confirms whether the liquid level height of the ink I in the second sub-tank 431 is less than the reference height by using the reference height detection section D2. In a case where the liquid level height of the ink I in the second sub-tank 431 is less than the reference height (YES), the processing proceeds to step S12, and in a case where the liquid level height of the ink I in the second sub-tank 431 is not less than the reference height (NO), step S11 is repeated.

### (Step S12)

The measurement control section 448 (the adjustment section) turns on the liquid feed pump 423 (also opens the liquid feed valve 424) and feeds the ink I from the first sub-tank 411 to the second sub-tank 431.

### (Step S13)

The measurement control section 448 (the adjustment section) confirms whether the liquid level height of the ink I in the second sub-tank 431 is the reference height by using the reference height detection section D2. In a case where the liquid level height of the ink I in the second sub-tank 431 is the reference height (YES), the processing proceeds to step S14, and in a case where the liquid level height of the ink I in the second sub-tank 431 is not less than the reference height (NO), steps S12 and S13 are repeated.

### (Step S14)

The measurement control section 448 (the adjustment section) turns off the liquid feed pump 423 (also closes the liquid feed valve 424) to stop feeding the ink I from the first sub-tank 411 to the second sub-tank 431. That is, when the liquid level height of the ink I in the second sub-tank 431 reaches the reference height, the supply of the ink I is stopped.

### (Step S15)

The measurement control section 448 (the correction section) acquires the output value of the Hall sensor 446 by using the ink liquid level height measuring apparatus 440 in a state in which the liquid level height of the ink I in the second sub-tank 431 is the reference height.

Then, the measurement control section 448 (the correction section) corrects the liquid level height as follows based on the output value of the Hall sensor 446 in a state in which the liquid level height of the ink I is the reference height.

As an example, it is assumed that a liquid level height L is obtained by the following calculation expression 1 based on an output value V of the Hall sensor 446.

$$\begin{matrix}[ 1 ] & \\ L = a \times V + b & ( Calculation Expression 1 )\end{matrix}$$

In the above calculation expression (linear expression), a coefficient a is a predetermined coefficient and is a slope of the calculation expression. In addition, a coefficient b is a predetermined coefficient and is an intercept of the calculation expression, but here, by correcting the coefficient b which is a constant term, the liquid level height of the ink I is accurately measured by using the Hall sensor 446 even when there is a change over time.

Specifically, at the start of use (initial stage) of the ink liquid level height measuring apparatus 440, steps S11 to S15 described above are executed. Then, an output value V of the Hall sensor 446 in a state in which the liquid level height of the ink I in the second sub-tank 431 is the reference height is acquired as an initial value b0.

Thereafter, for example, when the liquid level height of the ink I in the second sub-tank 431 becomes less than the reference height, steps S11 to S15 described above are executed. Then, through steps S11 to S15 described above, the output value V of the Hall sensor 446 in a state in which the liquid level height of the ink I in the second sub-tank 431 is the reference height is acquired as a current value bt. A difference Δb between the initial value b0 and the current value bt is obtained as the correction value of the coefficient b, and the measurement control section 448 obtains the liquid level height L from the output value V of the Hall sensor 446 by using the following calculation expression 2 to which the difference Δb is added as the correction term of the coefficient b. According to the calculation expression 2, the liquid level height of the ink I can be accurately measured by using the Hall sensor 446 even when there is a change over time.

$$\begin{matrix}[ 2 ] & \\ L = a \times V + ( b + Δ b ) = a \times V + ( b + b 0 - bt ) & ( Calculation Expression 2 )\end{matrix}$$

Here, a case where the relationship between the liquid level height L and the output value V of the Hall sensor 446 is expressed by a linear expression has been exemplified. However, even in a case where the relationship therebetween is an N-th order expression of a second order or higher, the constant term (intercept) may be corrected in the same manner as the linear expression.

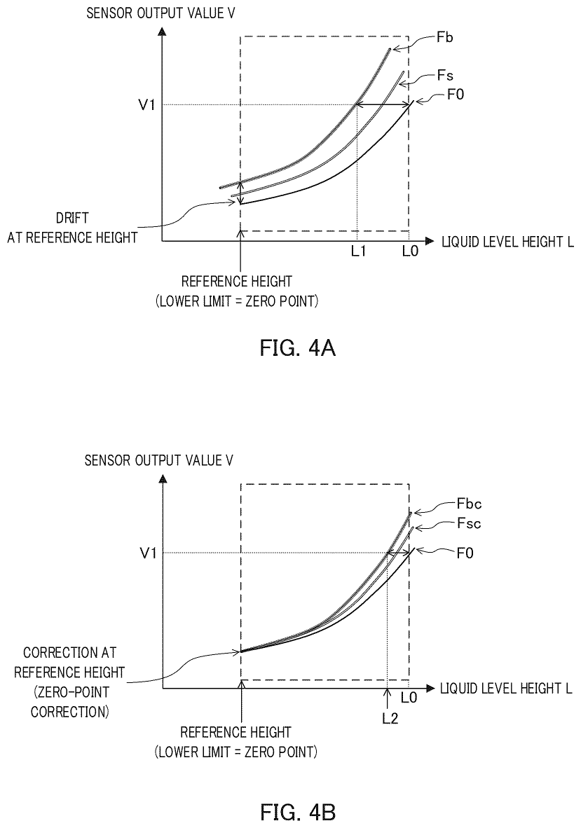

FIG. 4A is a graph illustrating the relationship between the liquid level height L before zero-point correction and the output value V of the Hall sensor 446. FIG. 4B is a graph illustrating the relationship between the liquid level height L after zero-point correction and the output value V of the Hall sensor 446. Note that the graphs of FIGS. 4A and 4B illustrate, as an example, a case where the relationship between the liquid level height L and the output value V of the Hall sensor 446 is expressed by a quadratic expression.

As described above, the Hall element used in the Hall sensor 446 has a characteristic that the output value thereof changes with time (drifts). For example, in FIG. 4A, a graph F0 is a graph illustrating the relationship between the liquid level height L and the output value V of the Hall sensor 446 at the start of use (initial stage) of the ink liquid level height measuring apparatus 440. When the ink liquid level height measuring apparatus 440 is used for a long time, the output value V of the Hall sensor 446 with respect to the liquid level height L greatly drifts (see a graph Fb) or slightly drifts (see a graph Fs) from the graph F0, for example, due to a use environment or the like.

As illustrated in FIG. 4A, when the output value V of the Hall sensor 446 drifts from the graph F0 as the initial graph to the graph Fb or Fs, the liquid level height L is obtained as a liquid level height indicated in a range between L0 and L1, for example, even in the case of the same output value V=V1, and the accuracy of obtaining the liquid level height is not high.

Accordingly, in the present embodiment, the correction amount Δb for aligning (matching) the zero point of the graph Fb or Fs with (to) the zero point of the graph F0 as the initial graph is obtained by using the current value bt acquired in steps S11 to S15 described above, and the zero-point correction is performed. As illustrated in FIG. 4B, graphs Fbc and Fsc are obtained by performing the zero-point correction on the graphs Fb and Fs, respectively.

As a result, as illustrated in FIG. 4B, the liquid level height L is obtained as a liquid level height indicated in a range between L0 and L1 which is narrower than the range between L0 and L2, for example, even in the case of the same output value V=V1, and the accuracy of obtaining the liquid level height improves.

Further, at a liquid level height close to the zero point (the lower limit), the drift amount in the graph Fbc or Fsc with respect to the graph F0 is smaller as illustrated in FIG. 4B, the accuracy of obtaining the liquid level height further improves.

Note that the term zero-point correction is used since the reference height here is the lower limit of the second sub-tank 431, but the above-described correction may be performed by using a known height such as the middle position, the upper limit or the like of the second sub-tank 431 as the reference height.

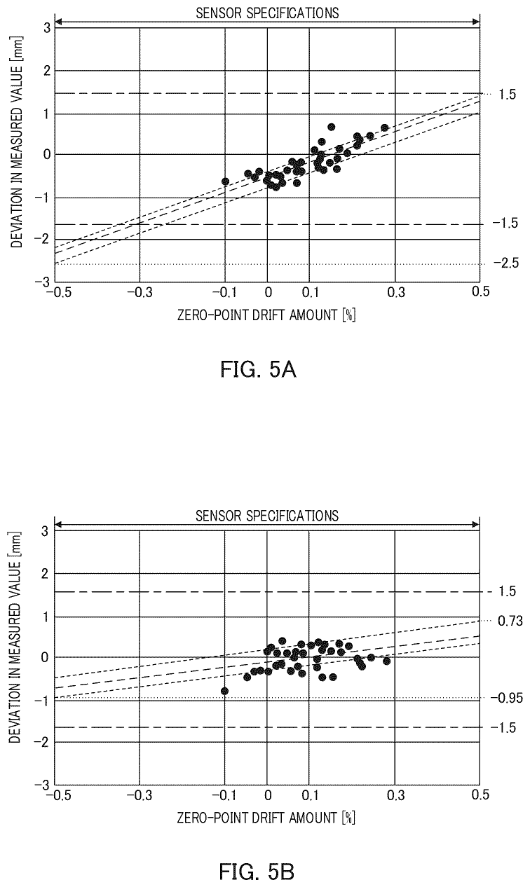

FIGS. 5A and 5B are graphs in which the effects of the above-described zero-point correction are compared and verified. FIG. 5A illustrates the relationship between the zero-point drift amount and the deviation in the measured value in the case of no zero-point correction. FIG. 5B illustrates the relationship between the zero-point drift amount and the deviation in the measured value in the case of zero-point correction.

Here, a sensor in which the specifications of the zero-point drift due to a change over time are ±0.5% is used as the Hall sensor 446, and the target value (target accuracy) of the deviation in the measured value is ±1.5 mm.

When the zero-point drift amount (%) and the deviation in the measured value (mm) were measured over a predetermined period of time by using the Hall sensor 446 as such with no zero-point correction, the results illustrated in FIG. 5A were obtained. In this period of time, the zero-point drift amount did not drift up to 0.5% or close to −0.5%. When the obtained results are linearly approximated and the deviations in the measured values at 0.5% and −0.5% are predicted, the deviation is 1.5 mm at 0.5% and −2.5 mm at −0.5%, and thus, the target value of ±1.5 mm for the deviation in the measured values could not be satisfied.

In contrast, when the zero-point drift amount (%) and the deviation in the measured value (mm) were measured over a predetermined period of time with zero-point correction, the results illustrated in FIG. 5B were obtained. Even in this period of time, the zero-point drift amount did not drift to 0.5% or close to −0.5%. When the obtained results are linearly approximated and the deviations in the measured values at 0.5% and −0.5% are predicted, the deviation is 0.73 mm at 0.5% and −0.95 mm at −0.5%, and thus, the target value of ±1.5 mm for the deviation in the measured value could be satisfied.

In this way, by performing the zero-point correction, the Hall sensor 446 can be used with the target accuracy of ±1.5 mm and the liquid level height can be accurately measured even when there is a change over time.

As described above, in the present embodiment, the inkjet printer 100 includes the ink liquid level height measuring apparatus 440. In addition, the ink liquid level height measuring apparatus 440 includes the adjustment section, which adjusts the liquid level height of the ink I to the reference height, and the correction section, which corrects the liquid level height based on the output of the Hall sensor 446 when the liquid level height is the reference height.

According to the present embodiment configured as described above, the liquid level height is corrected based on the output of the Hall sensor 446 when the liquid level height is the reference height, and thus, it is possible to accurately measure the liquid level height of ink by using the Hall sensor 446 even when there is a change over time.

Further, in the ink liquid level height measuring apparatus 440, the Hall sensor 446 includes the magnetic body 447 at the housing of the Hall sensor 446 as described above, and thus, it is possible to measure the liquid level height of the ink I with much higher accuracy.

### [Correction 2]

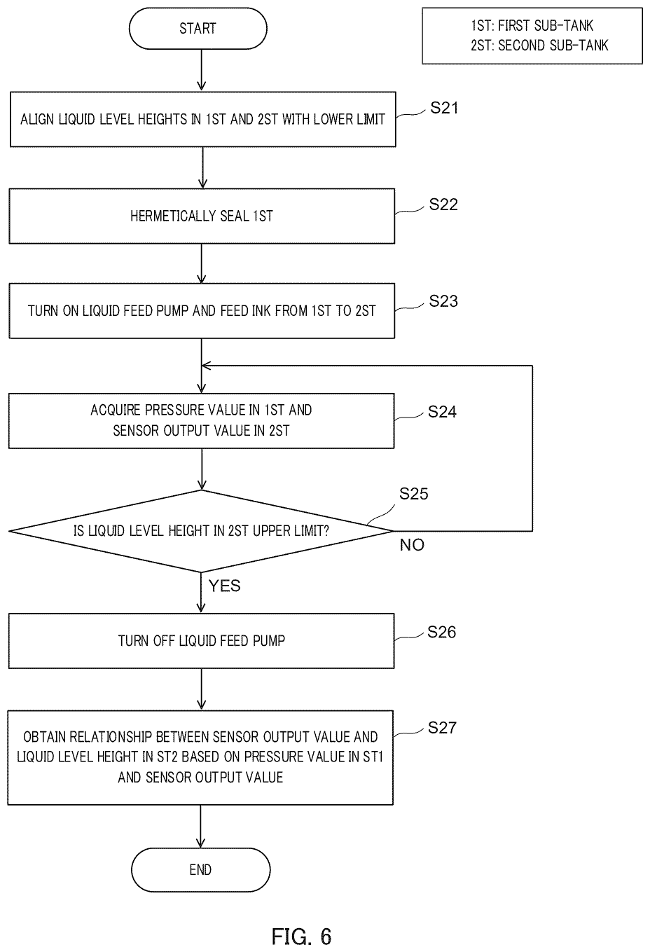

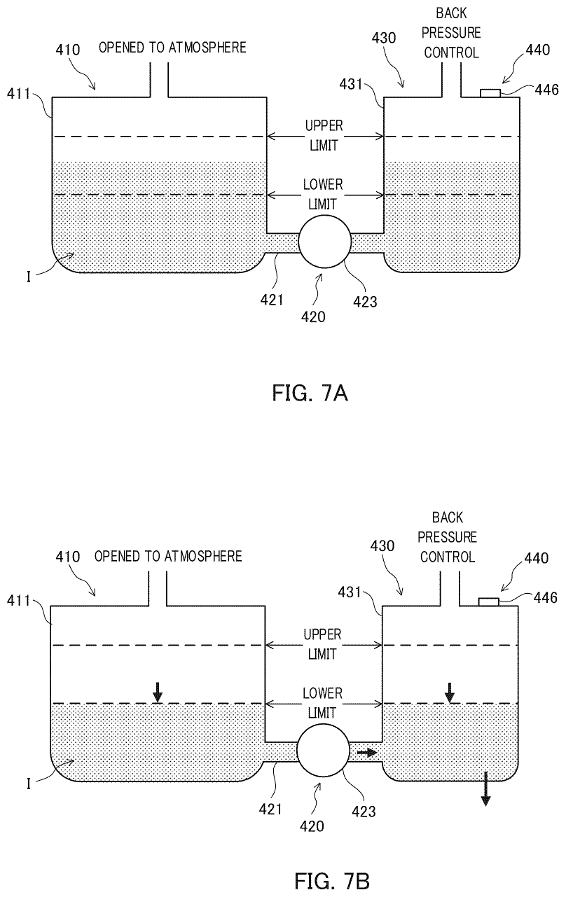

Correction 2 (entire-region correction) which is another example of correction will be described with reference to FIGS. 6 to 7D together with FIG. 1.

In the above-described correction 1, the ink liquid level height measuring apparatus 440 may further include, in consideration of a case where the difference Δb between the initial value b0 and the current value bt becomes equal to or more than a predetermined value, an acquisition section that acquires a relational expression for correcting the liquid level height in the entire liquid level height region. Here, the correction section corrects the liquid level height by using the relational expression acquired by the acquisition section.

Here, as an example, in a case where the difference Δb becomes 0.5% (the predetermined value) or more with respect to the initial value b0, that is, in a case where Δb/b0×100=(b0−bt)/b0×100≥0.5, the acquisition section acquires a relational expression in which the entire-region correction can be performed.

As can be seen from FIGS. 4A and 4B, a drift of the sensor output value of the Hall sensor 446 includes a change in the vertical axis direction and a change in the inclination. In a case where a change in the vertical axis direction, that is, the difference Δb described above becomes larger than the predetermined value, the measurement accuracy of the liquid level height of the ink I is affected due to the influence of the change in the inclination, and thus, the acquisition section acquires a relational expression in which the entire-region correction can be performed.

FIG. 6 is a flowchart illustrating entire-region correction of the Hall sensor 446 of the ink liquid level measuring apparatus 440. FIG. 7A illustrates initial states of the first sub-tank 411 and the second sub-tank 431 in the entire-region correction described in FIG. 6. FIG. 7B illustrates a state in which liquid level alignment is performed in the first sub-tank 411 and the second sub-tank 431 in the entire-region correction described in FIG. 6. FIG. 7C illustrates a state in which the first sub-tank 411 is hermetically sealed in the entire-region correction described in FIG. 6. FIG. 7D illustrates a state in which the ink I is being fed from the first sub-tank 411 to the second sub-tank 431 in the entire-region correction described in FIG. 6.

Note that, in FIG. 6, the first sub-tank 411 is denoted by “1ST”, and the second sub-tank 431 is denoted by “2ST”. Further, in FIGS. 7A to 7D, descriptions of some configurations of the first sub-tank section 410, the liquid feed section 420, and the second sub-tank section 430 are omitted, and a description of the head module 50 is also omitted. Further, the reference heights in the reference height detection sections D1 and D2 here are the lower limit of the first sub-tank 411 and the lower limit of the second sub-tank 431, respectively.

As an initial state of the entire-region correction to be described below, both the liquid level heights of the ink I in the first sub-tank 411 and the second sub-tank 431 are between the upper and lower limits as illustrated in FIG. 7A. At this time, in the first sub-tank 411, the valve 417 (see FIG. 1) is in an open state by the control of the measurement control section 448 (the acquisition section), and the upper space of the first sub-tank 411 is in a state of being opened to the atmosphere. In addition, in the second sub-tank 431, the pneumatic pump 432 (see FIG. 1) controls the pressure in the upper space of the second sub-tank 431 to a desired pressure (for example, −3 kPa) by the control of the measurement control section 448 (the acquisition section).

### (Step S21)

The measurement control section 448 (the acquisition section) aligns each of the liquid level heights of the ink I in the first sub-tank 411 and the second sub-tank 431 with the lower limit as illustrated in FIG. 7B.

For example, the measurement control section 448 (the acquisition section) drives the liquid feed pump 423 to feed the ink I from the first sub-tank 411 to the second sub-tank 431, and aligns the liquid level height of the ink I in the first sub-tank 411 with the lower limit by using the reference height detector D1 (see FIG. 1). Thereafter, the measurement control section 448 (the acquisition section) ejects the ink I from the second sub-tank 431 by using the head module 50, and aligns the liquid level height of the ink I in the second sub-tank 431 with the lower limit by using the reference height detection section D2 (see FIG. 1).

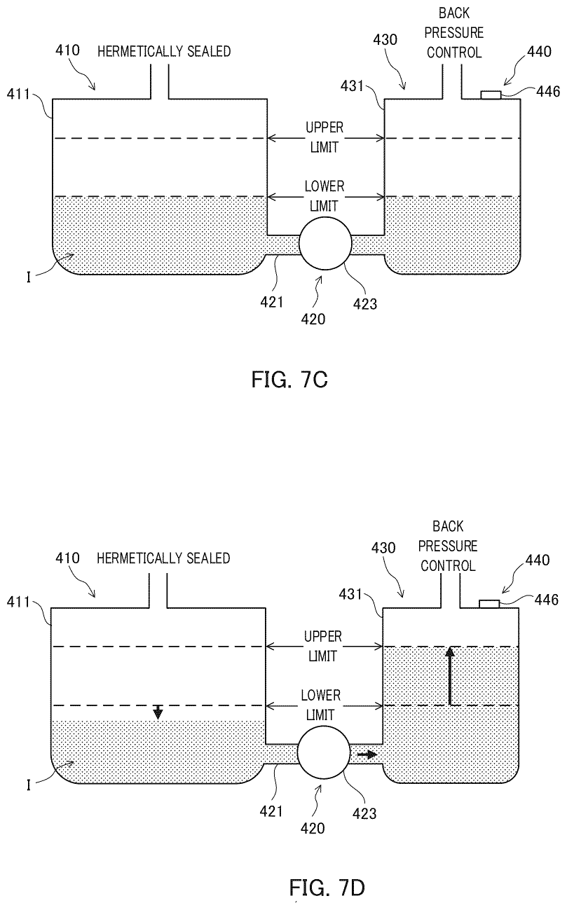

In the first sub-tank 411, when the liquid level height of the ink I deviates from the lower limit, a relational expression L=f(P) which will be described later with reference to FIG. 8A changes, and the entire-region correction becomes inaccurate. Accordingly, it is important to align the liquid level height of the ink I in the first sub-tank 411 with the lower limit, and any other reference height detection apparatus may also be used in addition to the reference height detection section D1 or instead of the reference height detection section D1.

Further, in the second sub-tank 431, when the liquid level height of the ink I deviates from the lower limit, the liquid level height deviates from the true value. Accordingly, it is also important to align the liquid level height of the ink I in the second sub-tank 431 with the lower limit, and any other reference height detection apparatus may also be used in addition to the reference height detection section D2 or instead of the reference height detection section D2.

### (Step S22)

The measurement control section 448 (the acquisition section) causes the valve 417 (see FIG. 1) to be in the closed state to hermetically seal the first sub-tank 411 as illustrated in FIG. 7C.

### (Step S23)

After hermetically sealing the first sub-tank 411, the measurement control section 448 (the acquisition section) drives the liquid feed pump 423 to feed the ink I from the first sub-tank 411 to the second sub-tank 431.

### (Step S24)

The measurement control section 448 (the acquisition section) acquires the pressure value in the hermetically sealed first sub-tank 411 by using the pressure sensor 418 (see FIG. 1), and acquires the sensor output value of the Hall sensor 446 (see FIG. 1).

Although details will be described later with reference to FIG. 8A, the pressure value in the first sub-tank 411 changes in association with a change in the liquid level height of the ink I in the first sub-tank 411, and the sensor output value of the Hall sensor 446 also changes in association with a change in the liquid level height of the ink I in the second sub-tank 431. By using the pressure value and the sensor output value which change in this way, a relational expression to be described later is obtained and the entire-region correction is performed.

### (Step S25)

The measurement control section 448 (the acquisition section) confirms whether the liquid level height of the ink I in the second sub-tank 431 is the upper limit. In a case where the liquid level height of the ink I in the second sub-tank 431 is the upper limit (YES), the processing proceeds to step S26, and in a case where the liquid level height of the ink I in the second sub-tank 431 is not the upper limit, that is, is less than the upper limit (NO), steps S24 and S25 are repeated.

As for the upper limit of the second sub-tank 431, for example, a reed switch similar to the reed switch 445 used for the reference height detector D2 may be provided in the position of the upper limit, and it may be confirmed by using the reed switch whether the liquid level height of the ink I in the second sub-tank 431 is the upper limit.

In this way, as illustrated in FIG. 7D, the measurement control section 448 (the acquisition section) changes the liquid level height of the ink I in the second sub-tank 431 from the lower limit to the upper limit. At this time, the measurement control section 448 (the acquisition section) acquires the pressure value in the first sub-tank 411 and the sensor output value of the Hall sensor 446 of the second sub-tank 431 in association with the liquid level change from the lower limit to the upper limit.

When the ink I is fed from the first sub-tank 411 to the second sub-tank 431, the liquid level in the first sub-tank 411 lowers. Since the first sub-tank 411 is hermetically sealed, the volume of the air increases by the volume of the fed ink I, and the pressure value in the first sub-tank 411 decreases. On the other hand, in association with the feeding of the ink I, the liquid level in the second sub-tank 431 increases, and the sensor output value of the Hall sensor 446 of the second sub-tank 431 increases. The measurement control section 448 (the acquisition section) acquires such a change in the pressure value and a change in the sensor output value in association with each other.

### (Step S26)

The measurement control section 448 (the acquisition section) turns off the liquid feed pump 423 (also closes the liquid feed valve 424) to stop feeding the ink I from the first sub-tank 411 to the second sub-tank 431.

### (Step S27)

The measurement control section 448 (the acquisition section) obtains a relationship (relational expression) between the sensor output value and the liquid level height in the second sub-tank 431 based on the pressure value in the first sub-tank 411 and the sensor output value of the Hall sensor 446 of the second sub-tank 431.

Here, the relational expression obtained by the entire-region correction will be described with reference to FIGS. 8A and 8B. FIG. 8A illustrates the relationships of the liquid level and the sensor output value in the second sub-tank 431 to the pressure value in the first sub-tank 411 in the entire-region correction illustrated in FIG. 6. FIG. 8B is a graph illustrating the relationship (relational expression) between the sensor output value and the liquid level, which is obtained from the relationships illustrated in FIG. 8A. Note that, even in FIGS. 8A and 8B, the first sub-tank 411 is denoted by “1ST”, and the second sub-tank 431 is denoted by “2ST”.

First, by substantially the same method as the method described with reference to FIGS. 6 and 7A to 7D, a relational expression of the liquid level height L in the second sub-tank 431 with respect to a pressure value P in the first sub-tank 411 is obtained in advance by using an experimental value or a calculated value. That is, while the sensor output value of the Hall sensor 446 of the second sub-tank 431 is acquired in the method described with reference to FIGS. 6 and 7A to 7D, the liquid level height L in the second sub-tank 431 is obtained here instead by experimentation or calculation. Thus, the relational expression L=f(P) illustrated in FIG. 8A, that is, the relational expression of the liquid level height L in the second sub-tank 431 with respect to the pressure value P in the first sub-tank 411 is obtained. The measurement control section 448 stores the relational expression L=f(P) in the storage section.

The measurement control section 448 performs the method described with reference to FIGS. 6 and 7A to 7D, that is, the entire-region correction, in a state in which the relational expression L=f(P) is stored in the storage section. In FIG. 8A, the “initial state” is the state illustrated in FIG. 7A. Further, the “liquid level alignment” is the state illustrated in step S21 in FIG. 6, and FIG. 7B. Further, the “hermetically sealing” is the state illustrated in step S22 in FIG. 6, and FIG. 7C. Further, the “feeding” is the state illustrated in steps S23 to S26 in FIG. 6, and FIG. 7D. At the time of the “feeding”, the relational expression P=g(V) illustrated in FIG. 8A, that is, the relational expression of the sensor value V of the Hall sensor 446 of the second sub-tank 431 with respect to the pressure value P in the first sub-tank 411 is obtained.

Then, the measurement control section 448 (the acquisition section) obtains the relational expression L=f(g(V)) by using the relational expression L=f(P) stored in advance in the storage section and the relational expression P=g(V) obtained by the entire-region correction. That is, the measurement control section 448 (the acquisition section) obtains the relational expression L=f(g(V)) of the sensor-output value V of the Hall sensor 446 of the second sub-tank 431 with respect to the liquid level height L in the second sub-tank 431 (see FIG. 8B). By this relational expression L=f(g(V)), it is possible to calculate a more accurate liquid level height in the range between the lower and upper limits of the second sub-tank 431.

As described above, the measurement control section 448 (the acquisition section) obtains the relational expression L=f(g(V)). In addition, even when there is a change over time, the measurement control section 448 (the correction section) performs the entire-region correction in the range between the lower and upper limits of the second sub-tank 431 by using the relational expression L=f(g(V)), and thus, it is possible to calculate a more accurate liquid level height.

Note that the correction 2 may be executed without executing the correction 1. However, the correction 2 involves consumption of the ink I. For this reason, it is desirable, in consideration of the consumption of the ink I, to perform the correction 1, whereas in a case where the difference Δb becomes equal to or more than the predetermined value, it is desirable to perform the correction 2.

### [Abnormality Determination Method]

Even when there is a change over time, an accurate liquid level height can be measured by the above-described correction 1 or 2. By using this, the ink liquid level height measuring apparatus 440 may include a determination section that performs abnormality determination of the liquid feed section 420.

For example, while the ink liquid level height measuring apparatus 440 measures the liquid level height of the ink I in the second sub-tank 431, the measurement control section 448 (the determination section) aligns (lowers) the liquid level height with (to) the target height by ejecting the ink I. This target height may be a height different from the above-described reference height (for example, the lower limit), and can be set to an appropriate height as long as the liquid level height in the second sub-tank 431 after the feeding of the ink I does not exceed the upper limit of the second sub-tank 431.

Note that, in a case where the target height is the above-described reference height (for example, the lower limit), the above-described correction 1 may be executed at the time of the determination at the determination section.

After the liquid level height of the ink I in the second sub-tank 431 is aligned with the target height, the measurement control section 448 (the determination section) drives the liquid feed pump 423 for a predetermined time (for example, 10 seconds) to feed the ink I from the first sub-tank 411 to the second sub-tank 431. As the predetermined time for which the liquid feed pump 423 is driven, an appropriate time is settable as long as the liquid level height in the second sub-tank 431 after the feeding of the ink I does not exceed the upper limit of the second sub-tank 431.

With the above-described procedure, the measurement control section 448 (the determination section) can obtain the liquid level height with respect to the target height or the rate of change in the liquid level height for the driving time of the liquid feed pump 423. Then, the measurement control section 448 (the determination section) can determine the state of the liquid feed section 420 (the tank supply path 421) based on the liquid level height with respect to the reference height or the rate of change in the liquid level height.

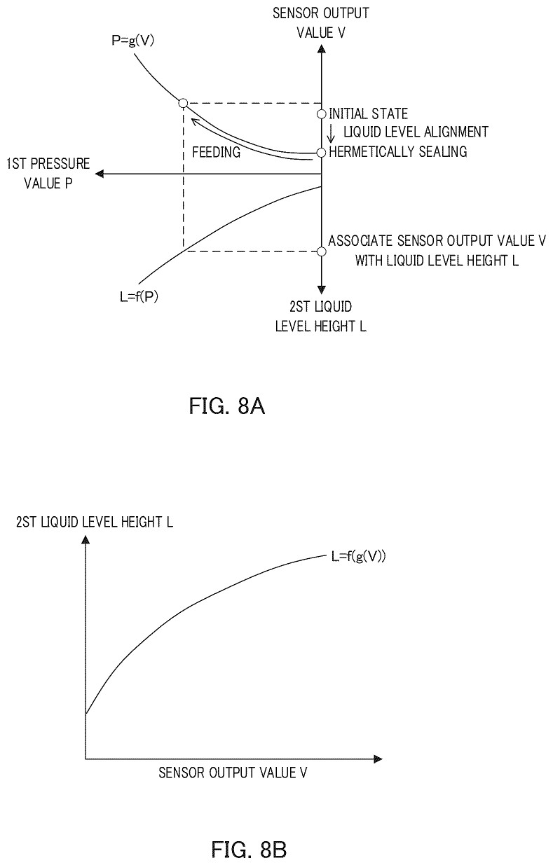

FIG. 9 is a graph illustrating the relationship between the driving time of the liquid feed pump 423 and the liquid level height of the ink I in the second sub-tank 431 from a state in which the ink supply section 40 is a new product to a state in which the ink supply section 40 is determined to have a failure.

As illustrated in FIG. 9, the liquid level height of the ink I in the second sub-tank 431 increases linearly with respect to the driving time of the liquid feed pump 423, but the rate of change in the liquid level height decreases from the state in which the ink supply section 40 is a new product to the state in which the ink supply section 40 is determined to have a failure.

For example, the liquid feed section 420 in the ink supply section 40 includes the filter 425 for filtering the ink I. Since clogging progresses over time in the filter 425, the feed amount of the ink I fed from the first sub-tank 411 to the second sub-tank 431 also decreases over time.

Accordingly, as described above, the measurement control section 448 (the determination section) drives the liquid feed pump 423 for a predetermined time to feed the ink I from the first sub-tank 411 to the second sub-tank 431. Then, the measurement control section 448 (the determination section) determines the state of the liquid feed section 420 (whether the liquid feed section 420 has a failure) based on the liquid level height with respect to the reference height (for example, the position before the feeding) or the rate of change in the liquid level height.

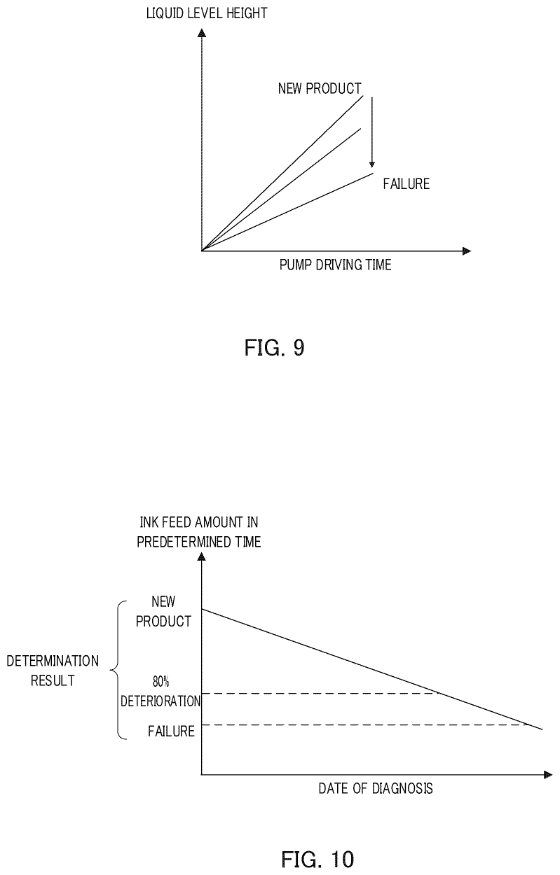

FIG. 10 is a graph illustrating a determination result obtained by making determination based on a change over time in the liquid feed amount of the ink I supplied for a predetermined time. In the present embodiment, the ink liquid level height measuring apparatus 440 measures the liquid level height as a continuous value, unlike the apparatuses disclosed in PTLs 1 and 2 that detect the liquid level height discretely. For this reason, the ink liquid level height measuring apparatus 440 can determine the degree of deterioration of the liquid feed section 420 between the state of a new product and the state of a failure as illustrated in FIG. 10 by monitoring the liquid level height with respect to the reference height or the rate of change in the liquid level height over time (for example, every day).

Further, as illustrated in FIG. 10, the ink liquid level height measuring apparatus 440 can also predict the degree of deterioration and the time of a failure by monitoring the liquid level height with respect to the reference height and the rate of change in the liquid level height over time. In this way, the degree of deterioration can be predicted, and thus, it is possible to prevent the liquid feed section 420 from having a failure to cause the inkjet printer 100 to stop, for example, by predicting the time of 80% deterioration and replacing a deteriorated component(s) at the predicted time of 80% deterioration. That is, it is possible to prevent the liquid feed section 420 from having a failure to cause the inkjet printer 100 to stop by replacing a deteriorated component(s) before a failure occurs.

Further, when the liquid feed pump 423 is driven for a predetermined time to feed the ink I from the first sub-tank 411 to the second sub-tank 431, the location of a failure in the liquid feed section 420 can also be specified by changing the pump duty of the liquid feed pump 423.

In the liquid feed section 420, mainly the liquid sending pump 423 or the filter 425 becomes the portion of a failure. According to the knowledge of the inventor, the pump duty may be set to a relatively low value in a case where it is desired to perform deterioration determination of the liquid feed pump 423, whereas the pump duty may be set to a relatively high value in a case where it is desired to perform deterioration determination of the filter 425.

For example, it is assumed that the settable range of the pump duty of the liquid feed pump 423 is 20% to 100%. In this case, the pump duty is set to, for example, 20% in a case where deterioration determination of the liquid feed pump 423 is desired, whereas the pump duty is set to, for example, 100% in a case where deterioration determination of the filter 425 is desired.

This is because the resistance due to clogging of the filter 425 increases when the pump duty is set to a relatively high value since the resistance (pressure loss) of the filter 425 increases with the square of the flow rate of the ink I, and thus, deterioration determination of the filter 425 can be performed.

It is also because the influence of the resistance of the filter 425 becomes small and the influence of the deterioration of the liquid feed pump 423 becomes large when the pump duty is set to a relatively low value, and thus, deterioration determination of the liquid feed pump 423 can be performed. In addition, when the pump duty is a relatively low value, the flow rate of the ink I in the liquid feed pump 423 also becomes slow. For this reason, for example, in a case where a gap due to a sticking material or the like is formed in a check portion in the liquid feed pump 423, the flow path resistance of the portion decreases, the backflow is likely to occur, and the liquid feed amount decreases, and thus, it is possible to perform deterioration determination of the liquid feed pump 423.

As described above, the measurement control section 448 (the determination section) determines the state of the liquid feed section 420 based on the liquid level height with respect to the reference height or the rate of change in the liquid level height, and thus, it is possible to determine whether the liquid feed section 420 has a failure, and it is also possible to predict the degree of deterioration or the time of a failure.

Note that, the following supplementary note will be further disclosed with respect to the above description.

### (Supplementary Note 1)

An ink liquid level height measuring apparatus that measures a liquid level height of ink in a container, the ink liquid level height measuring apparatus including:
a float that includes a magnet and moves in association with a change in the liquid level height;
a Hall element that detects, as a continuous value, a change in magnetic flux density due to the magnet that moves together with the float;
an acquirer that acquires a pressure value of air in a supply source container and an output value of the Hall element while supplying the ink from the supply source container in a hermetically sealed state to the container to change the liquid level height from a lower limit of the container to an upper limit of the container, and acquires, based on the pressure value and the output value, a relational expression for correcting the liquid level height in an entire region between the lower limit and the upper limit; and
a corrector that corrects the liquid level height by using the relational expression.

Any of the embodiment described above is only illustration of an exemplary embodiment for implementing the present invention, and the technical scope of the present invention shall not be construed limitedly thereby. That is, the present invention can be implemented in various forms without departing from the gist or the main features thereof.

For example, in the above-described embodiment, the measurement control section 448 functions as the above-described adjustment section, correction section, acquisition section, and determination section, but the control section 90 may be configured to function as the above-described adjustment section, correction section, acquisition section, and determination section.

Although embodiments of the present invention have been described and illustrated in detail, the disclosed embodiments are made for purpose of illustration and example only and not limitation. The scope of the present invention should be interpreted by terms of the appended claims.

What is claimed is:

1. An ink liquid level height measuring apparatus that measures a liquid level height of ink in a container, the ink liquid level height measuring apparatus comprising:
a float that includes a magnet and moves in association with a change in the liquid level height;
a Hall element that detects, as a continuous value, a change in magnetic flux density due to the magnet that moves together with the float; and
at least one hardware processor, wherein
the at least one hardware processor
adjusts the liquid level height to a reference height, and
acquires an output value of the Hall element and corrects the liquid level height based on the output value, the output value being an output value when the liquid level height is the reference height.

2. The ink liquid level height measuring apparatus according to claim 1, wherein
a housing of the Hall element includes a magnetic body.

3. The ink liquid level height measuring apparatus according to claim 1, wherein
the at least one hardware processor corrects the liquid level height based on an initial value of an output of the Hall element and a current value of the output of the Hall element, the initial value being a value when the liquid level height is the reference height.

4. The ink liquid level height measuring apparatus according to claim 3, wherein
the at least one hardware processor adds, as a correction term, a difference between the initial value and the current value to a calculation expression for obtaining the liquid level height to correct the liquid level height.

5. The ink liquid level height measuring apparatus according to claim 4, wherein
the at least one hardware processor
acquires, in a case where the difference is 0.5% or more with respect to the initial value, a relational expression for correcting the liquid level height in an entire region of the liquid level height, the entire region being a region between a lower limit of the liquid level height and an upper limit of the liquid level height, and
corrects the liquid level height by using the relational expression.

6. The ink liquid level height measuring apparatus according to claim 5, wherein
the at least one hardware processor acquires a pressure value of air in a supply source container and an output value of the Hall element while supplying the ink from the supply source container in a hermetically sealed state to the container to change the liquid level height in the container from the lower limit to the upper limit, and acquires the relational expression based on the pressure value and the output value.

7. The ink liquid level height measuring apparatus according to claim 1, wherein
the at least one hardware processor performs determination of a state of an ink supply path to the container based on the liquid level height with respect to the reference height or a rate of change in the liquid level height.

8. The ink liquid level height measuring apparatus according to claim 7, wherein
the at least one hardware processor, during the determination,
adjusts the liquid level height to the reference height, and
acquires an output value of the Hall element when the liquid level height is the reference height.

9. The ink liquid level height measuring apparatus according to claim 7, wherein
the at least one hardware processor performs the determination of the state of the ink supply path based on the rate of change in the liquid level height in a case where the ink has been supplied to the container for a predetermined time.

10. An image forming apparatus, comprising:
a container that stores ink;
an image former that forms an image by using the ink supplied from the container; and
the ink liquid level height measuring apparatus according to claim 1.

11. The image forming apparatus according to claim 10, wherein
the at least one hardware processor, during an image formation by the image former,
adjusts the liquid level height to the reference height, and
acquires an output value of the Hall element when the liquid level height is the reference height.

12. The image forming apparatus according to claim 11, wherein
the at least one hardware processor
supplies the ink to the container, when the liquid level height of the ink in the container becomes lower than the reference height due to the image formation by the image former, and
stops supplying the ink, when the liquid level height reaches the reference height.
